(19) United States
(12) Patent Application Publication
(10) Pub. No.: US 2012/0230364 A1
(43) Pub. Date: Sep. 13, 2012

(54) SENSOR ARRAY

(75) Inventors: Takanori Maeda, Kawagoe (JP); Kenjiro Fujimoto, Kofu (JP); Takahiro Kawano, Kariya (JP); Atsushi Onoe, Omiya (JP)

(73) Assignee: PIONEER CORPORATION, Kanagawa (JP)

(21) Appl. No.: 13/499,170

(22) PCT Filed: Sep. 29, 2009
(86) PCT No.: PCT/JP2009/004979

§ 371 Date: May 24, 2012

(51) Int. Cl. G01J 5/02

(52) U.S. Cl. 374/121

(57) ABSTRACT

A sensor array has a plurality of sensor elements, each of which has a rectangular frame shaped frame portion formed by connecting a plurality of frame pieces and a membrane that is constructed within the frame portion and has sensitivity as sensor, and the plurality of sensor elements are disposed in a planar shape in a state that the frame pieces in adjacent sensor elements are shared. The membrane has covexoconcave shape in which rectangular concave portions and rectangular convex portions are disposed in a web shape.

### TECHNICAL FIELD

The present invention relates to a sensor array having sensor elements in a membrane structure which respond to temperature change, pressure change, vibration or the like and are disposed in a planar shape.

### BACKGROUND ART

Generally, there has been known a thermal sensor in a membrane structure as this kind of sensor element (see Patent Document 1). The thermal sensor has a rectangular shaped membrane formed by a thermal sensitive element and an upper and a lower electrodes, and a pair of support arms which support to release the membrane on a substrate. Each support arm serves as a wiring and is formed by a thermal insulation material. The thermal sensitive element absorbs infrared rays and converts temperature change thereof to electrical signals, thereby the infrared rays can be detected.

A sensor array embedded in an infrared ray image sensor, a night vision apparatus or the like is formed by a plurality of thermal sensors in a matrix shape on a substrate.

[Patent Document 1] U.S. Pat. No. 6,087,661

### DISCLOSURE OF THE INVENTION

### Problems that the Invention is to Solve

In such a known thermal sensor, detection sensitivity can be enhanced by forming the membrane thinly and reducing thermal capacity. There arises a problem by forming the membrane thinly, in which warpage and crack occurs by stress (thermal stress, etc.) in a fabrication process, leading to an extremely low yield ratio. Further, by forming the membrane thinly, a resonance frequency is lowered. As to a sensor for a vehicle, problems such that the membrane thereof is crashed by the resonance, a connection portion between the support arm and the membrane is broken and the like occur. Still further, in a case that the thermal sensitive element of the membrane is made from ferroelectric, microphonics is generated by vibration and detection sensitivity drops off.

Also, in a sensor array having thermal sensors as sensor elements, since an area ratio of the membrane (sensitive portion) to the sensor array is small, the sensor array has to be large and has low detection sensitivity.

It is an advantage of the invention to provide a sensor array which is small enough and enhances a yield ratio and detection sensitivity.

### MEANS FOR SOLVING THE PROBLEMS

According to an aspect of the invention, there is provided a sensor array of the invention having a plurality of sensor elements, each of which has a frame portion in a polygonal shape formed by connecting a plurality of frame pieces and a membrane that is constructed within the frame portion and has sensitivity as sensor, and the plurality of sensor elements are disposed in a planar shape in a state that the frame pieces in adjacent sensor elements are shared, and a peripheral portion of each membrane that is connected at least on an inner periphery of the frame portion is formed in a plurality of convexoconcave shapes.

According to the structure, since the membrane can be integrated with the frame portion, strength of the membrane is increased and rigidity (strength) of the sensor array as a whole can be enhanced. Therefore, each membrane can be formed thinly while a yield ratio is boosted. Further, the integration of the membrane and the frame portion allows a resonance frequency of the membrane to be extremely high, thereby crash/breakage by vibration can be avoided and microphonics can not be generated. Still further, since a structure in which frame pieces are shared in adjacent sensor elements is applied, the rigidity (strength) of a whole sensor array can be increased and a ratio of a total area of the membrane to that of the frame portion can be increased, leading to high detection sensitivity.

In short, sharing (doubling) frame pieces has a sensor elements are respectively connected (joined) from in-plane opposite directions to one frame piece. In such a structure, since a frame piece has membranes at both sides, the strength thereof can be increased by the integrated frame piece and the membrane. Also, since width of the frame portion in the in-plane direction is made enough smaller than length of each sensor element to construct a narrow frame portion, the ratio of the total area of the membrane to that of the frame portion is increased. Further, strength of the membrane and the frame portion can be integrated, stress concentration at junction portions can be reduced and strength of the membrane itself can be improved. Therefore, the membrane can be formed thinly while the yield ratio is increased.

Further, it is preferable that configurations of the plurality of convexoconcave shapes in adjacent two sensor elements be different from each other.

According to the structure, the adjacent two sensor elements can have different resonance frequencies and a resonance frequency can be lowered for the whole sensor array. Therefore, crash/breakage by vibration can be avoided and a sensor array suitable for an in-vehicle can be provided.

Further, each convexoconcave shape extends to at least two directions and convex portions and concave portions are disposed in a web shape in a whole in-plane area of each membrane.

According to the structure, the strength of the membrane itself can be further increased, thereby the membrane can be formed thinly. The strength of the whole sensor array can also be enhanced.

While, it is preferable that the polygon be either one of a triangle, a quadrangle and a hexagon.

According to the structure, a sensor array having high rigidity can be formed in which an area ratio of the membrane (sensitive portion) is high.

Further, it is preferable that each membrane be formed by laminating an upper electrode layer, a pyroelectric layer and a lower electrode layer.

According to the structure, a sensor element (sensor array) having the high yield ratio and high detection sensitivity can be provided.

According to the invention as above, since frame pieces of adjacent sensor elements are shared, the ratio of the total area of the membrane to that of the frame portion can be increased while the rigidity (strength) as the whole sensor array is enhanced, resulting in high detection sensitivity. In short, the sensor array can be formed smaller and the yield ratio and the detection sensitivity can be enhanced.

### BRIEF DESCRIPTION OF THE DRAWINGS

FIG. 1 is a plan view of an infrared ray sensor according to a first embodiment of the invention.

FIG. 2A is a cross sectional view along with A-A line and FIG. 2B is a cross sectional view along with B-B line in FIG. 1.

FIG. 3 is a partial perspective view of the infrared ray sensor according to the first embodiment.

FIG. 4A is a partial perspective view of a modification around a frame portion and FIG. 4B is a partial perspective view of the other modification around the frame portion of the infrared ray sensor.

FIG. 5A is a cross sectional view of a modification and FIG. 5B is a cross sectional view of the other modificaton around the membrane.

FIGS. 6A-6F are explanatory views of a fabrication method of the infrared ray sensor according to the first embodiment.

FIG. 7 is a partial perspective view of the infrared ray sensor according to a modificaton of the first embodiment.

FIG. 8 is a partial plan view of a sensor array (infrared ray detection apparatus) applied with the infrared ray sensor of the first embodiment.

FIG. 9 is a partial plan view of the sensor array according to a modification.

FIG. 10A is a plan view of the infrared ray sensor and FIG. 10B is a cross sectional view according to a second embodiment of the invention.

### DESCRIPTION OF EXEMPLARY EMBODIMENTS

An infrared ray sensor as a MEMS sensor according to one embodiment of the invention and a sensor array using the infrared ray sensor will be explained with reference to accompanying drawings. The infrared ray sensor is fabricated by microfabrication technology with a silicon (wafer) material and the like, and is formed, as it is called, as a pyroelectric type infrared ray (far-infrared ray) sensor. Further, the infrared ray sensor forms a pixel (element) of the sensor array (infrared ray detection apparatus) fabricated in an array form.

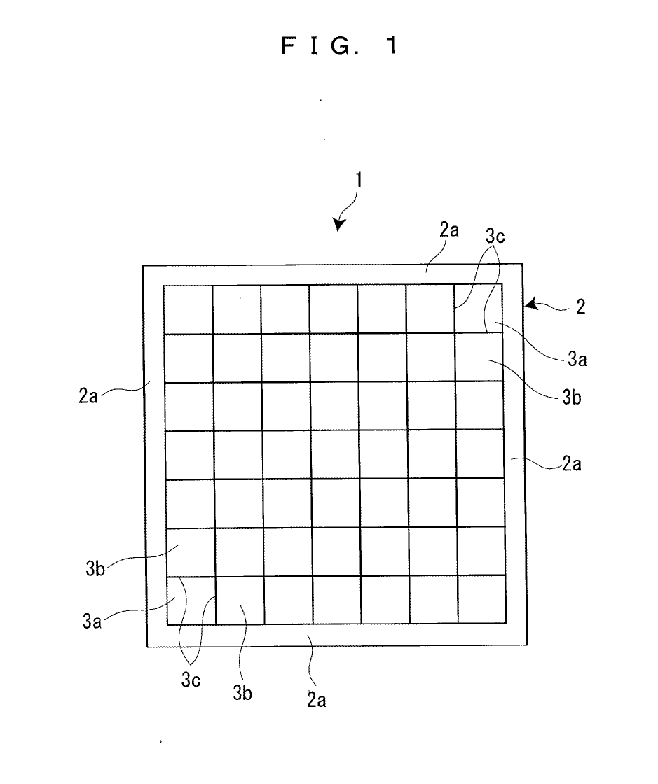

As illustrated in FIGS. 1 to 3, an infrared ray sensor 1 has a frame portion 2 formed in a rectangular frame shape, and a membrane 3 constructed within the frame portion 2 and formed in a convexoconcave shape as a whole. The membrane 3 is, as it is called, an infrared ray detection portion having sensitivity as sensor and is formed as thinner as possible. The frame portion 2 is a member which supports the thinly formed membrane 3 around four peripheries thereof, and connection wirings are patterned on a front surface thereof (not illustrated).

The frame portion 2 is formed in a square frame shape by deep reactive ion etching (RIE) from a front and a back (an upper and a lower) surfaces of a silicon substrate. Further, four frame pieces 2a constituting each side of the frame portion 2 have same thickness. Each side of the frame portion 2 of the embodiment is formed in size of approximately 50 μm. The frame portion is preferably formed in a polygonal shape such as a square, a rectangle, a triangle, a hexagon, etc. in consideration of strength.

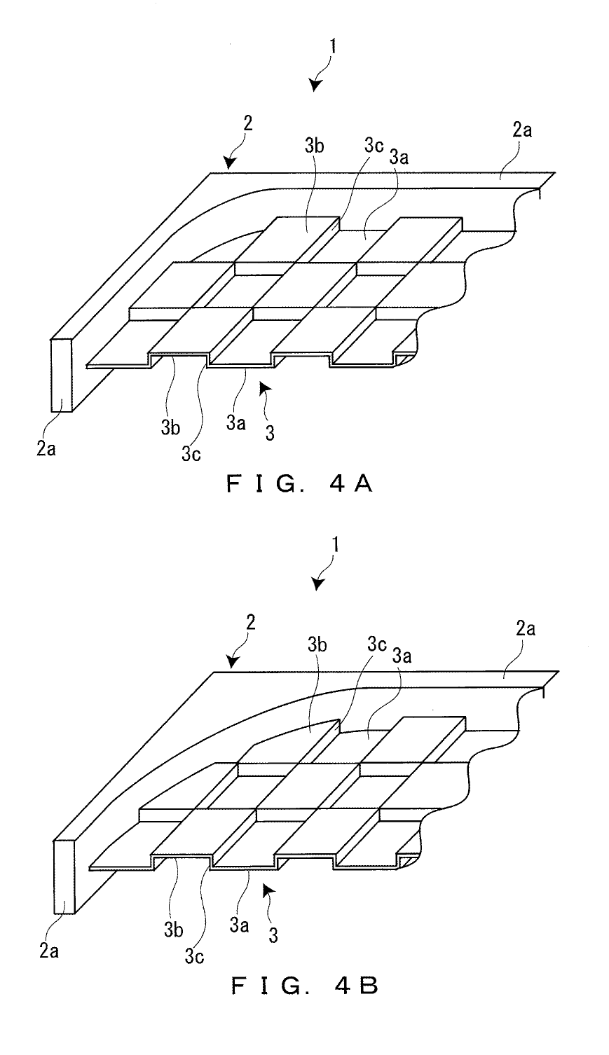

Further, as illustrated in FIGS. 4A and 4B, each corner of the frame portion 2 may be rounded. Each corner of the frame portion 2 in FIG. 4A is formed having a small R-shape (large curvature radius) and each corner thereof in FIG. 4B is formed having a large R-shape (small curvature radius). Such a structure can enhance rigidity of the frame portion 2 in a planar surface direction, resulting in increasing strength of the infrared ray sensor 1 overall.

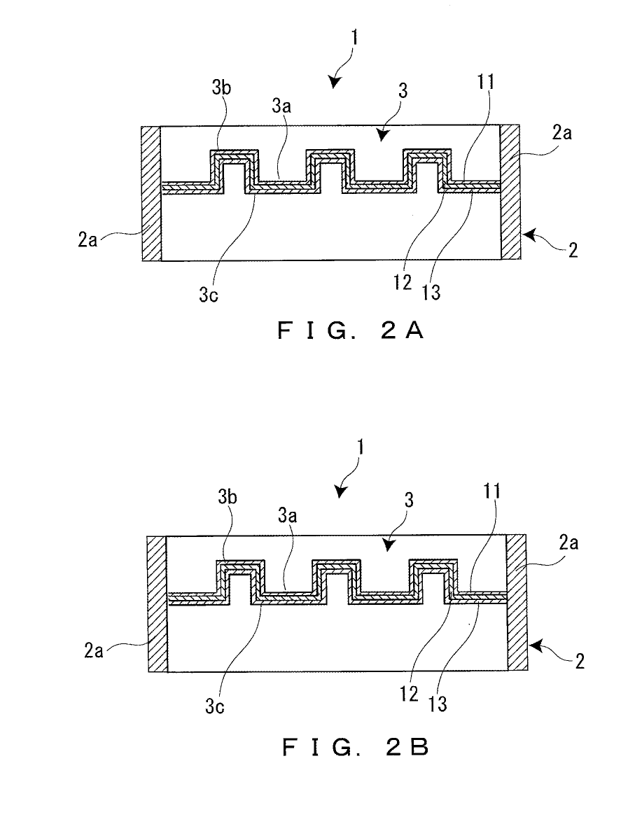

As illustrated in FIGS. 2A and 2B, the membrane 3 is formed by laminating an upper electrode layer 11, a pyroelectric layer (dielectric layer) 12 and a lower electrode layer 13 sequentially. The pyroelectric layer is made from, for example, PZT (Pb (Zr, Ti) O₃), SBT (SrBi₂Ta₂O₉), BIT (Bi₄Ti₃O₁₂), LT (LiTaO₃), LN (LiNbO₃), BTO (BaTiO₃), BST (BaSrTiO₃) or the like. In this case, a material having high dielectic constant (such as BST (BaSrTiO₃) or LT (LiTaO₃)) is preferably used for the pyroelectric layer 12 in consideration of detection sensitivity. The pyroelectric layer 12 of the embodiment is formed to have approximately 0.2 μm thickness.

The lower electrode layer 13 is made from, for example, Au, SRO, Nb-STO, LNO (LaNiO₃), etc. In this case, in consideration of film-forming of the pyroelectric layer 12 on the lower electrode layer 13, the lower electrode layer 13 is preferably made from a material having a same crystal structure as that of the pyroelectric layer 12. Further, the lower electrode layer 13 may be made from general Pt, Ir, Ti or the like.

On the other hand, the upper electrode layer 11 is made from, for example, Au-Black or the like to improve absorbability of infrared rays. The upper electrode layer 11 and the lower electrode layer 13 in the embodiment are formed having approximately 0.1 μm thickness, respectively.

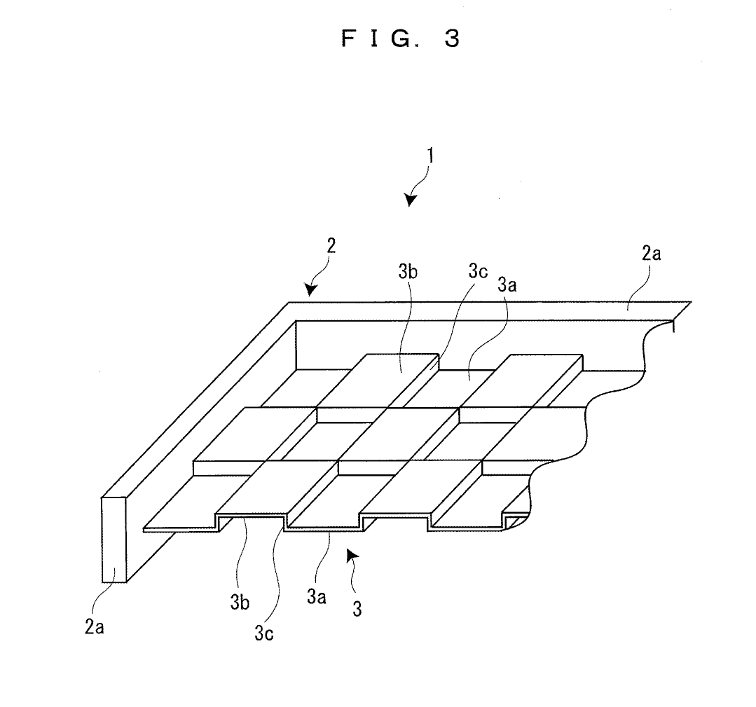

The membrane 3 having such a laminated structure is formed having a convexoconcave shape in a planar surface, in other words, two-dimensionally. More specifically, within a whole in-plane area of the membrane 3 where the convexoconcave shape extends to two orthogonal directions, square shaped concave portions 3a and square shaped convex portions 3b seen horizontally are disposed in a web form (matrix). In other words, four convex portions 3b are adjacent to one arbitrary concave portion 3a and four concave portions 3a are adjacent to one arbitrary convex portion 3b. Therefore, as illustrated in FIGS. 2A, 2B and 3, junction portions to each frame piece 2a have a convexoconcave shape seen horizontally. It is preferable that planar shapes of the concave portion 3a and the convex portion 3b be a polygon such as a rectangle, a triangle or the like, or a rectangle, a triangle or the like of which corners are rounded, and further, concave portions and convex portions having different shapes may exist in one membrane 3.

Further, adjacent concave portion 3a and convex portion 3b form a peripheral wall 3c in common, and the peripheral wall 3c constitutes a portion of the infrared ray detection portion and functions as reinforcement rib. A height of the peripheral wall 3c functioning as reinforcement rib, that is, length between the concave portion 3a and the convex portion 3b in a front and back surface direction is formed longer than thickness of the membrane 3. For example, in the embodiment, the length in the front and back surface direction is approximately 2.5 μm.

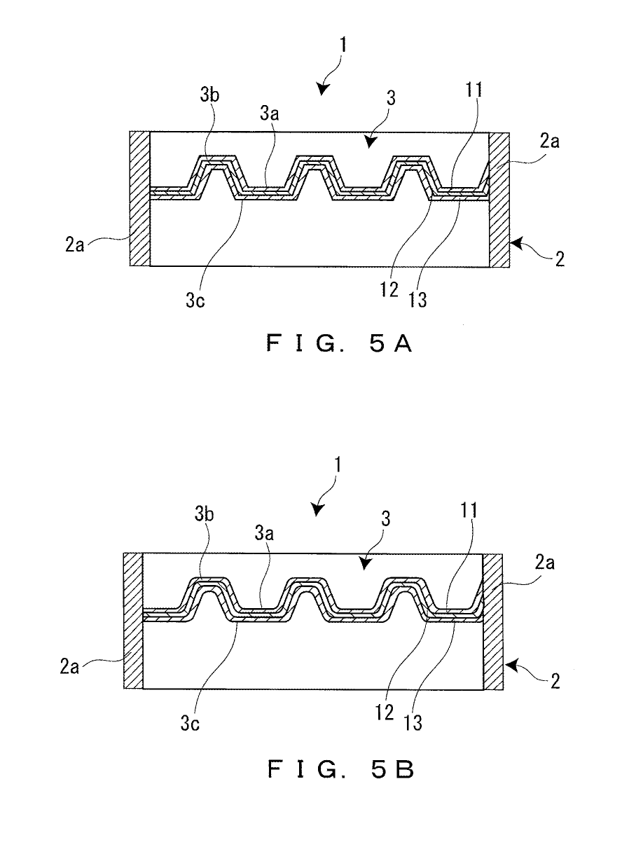

The reinforcement rib in the embodiment is formed at orthogonal to the in-plane direction of the membrane 3, but it may be inclined. More specifically, as illustrated in FIG. 5A, the convexoconcave shape of the membrane 3 is a cross sectional shape in which upside-down trapezoidal concave portions 3a and trapezoidal convex portions 3b are connected alternately. In this case, as illustrated in FIG. 5B, corners and angular portions are preferably rounded (formed in an R-shape). Having the rounded portions is also applied in the embodiment of FIGS. 2A and 2B. Thus, rigidity of the membrane 3 in the front and back surface direction can be increased and strength of the infrared ray sensor 1 with the frame portion 2 in overall can be enhanced.

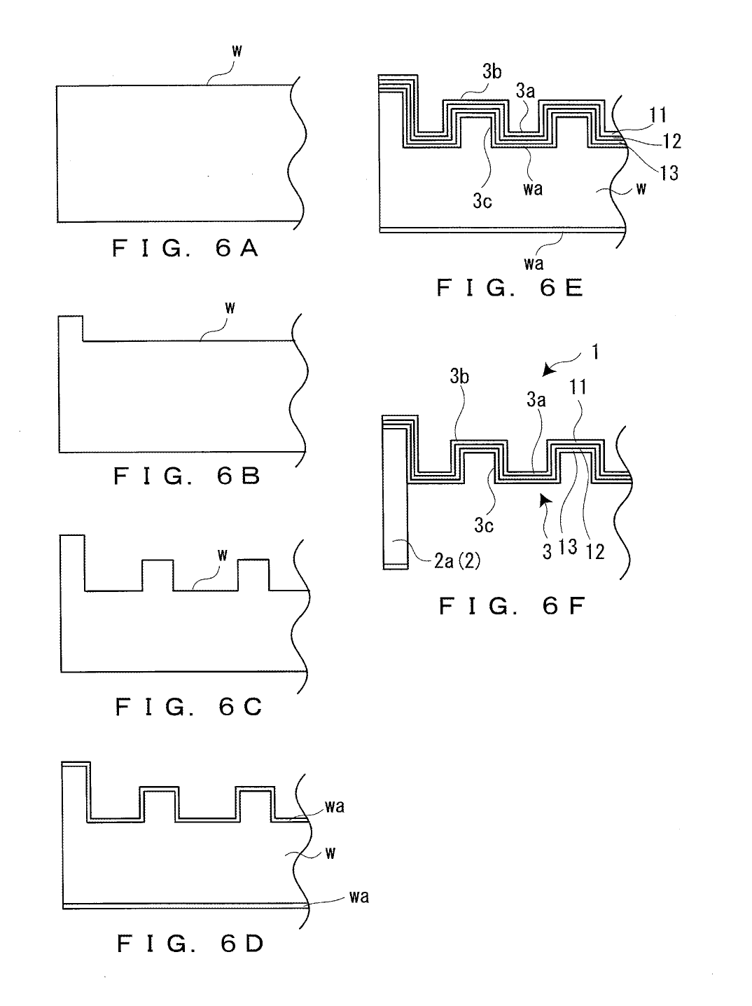

Referring to FIGS. 6A to 6F, a fabrication method of the infrared ray sensor 1 will be explained. The infrared ray sensor 1 in the embodiment is fabricated by microfabrication technology of a semi-conductor with a silicon substrate (wafer) W. The silicon substrate W coated with resist by photo lithography (FIG. 6A) is firstly etched (deep reactive ion etching: anisotropic etching) from an upper (front) side, and a portion to be a top surface of the convex portion 3b (portion corresponding to a back surface of the lower electrode layer 13 at the convex portion 3b) is formed (FIG. 6B). Similarly, a second etching (deep reactive ion etching: anisotropic etching) is performed from the upper (front) side and portions of a plurality of concave portions 3a (concave portions at the back surface of the lower electrode layer 13) are formed (FIG. 6C). Then, oxidized films (SiO₂) Wa are formed on the front and back surfaces of the silicon substrate W (FIG. 6D) by a thermal oxidation process.

Then, a portion to become the membrane 3 later is film-formed by epitaxial growth (CVD) with the lower electrode layer 13, the pyroelectric layer 12 and the upper electrode layer 11 sequentially on a surface of the silicon substrate W, that is, on the oxidized film Wa (FIG. 6E). In the epitaxial growth, buffer layers (not illustrated) are preferably provided especially between the oxidized film Wa and the lower electrode layer 13 for high quality film-forming, respectively. The buffer layers are preferably formed by YSZ, CeO₂, Al₂O₃ or STO.

Finally, a third etching (for example, isotropic etching by wet etching) is performed from the back surface side or from the front side by reversing the sides of the silicon substrate W to remove a substrate portion to be a lower side of the membrane 3 (FIG. 6F). In this case, the lower electrode layer 13 of the membrane 3 is made to function as etching stop layer and the frame portion 2 is left by managing etching time. In place of the third etching, the substrate portion to be the lower side of the membrane 3 may be formed as sacrifice layer such as phosphate glass and the sacrifice layer may be removed from the front side. The oxidized film Wa is not necessarily removed completely.

In such a structure, since the membrane 3 is formed in a convexoconcave shape, strength can be integrally improved with the frame portion 2 and strength of the membrane 3 itself can be enhanced. Therefore, breakage in a fabrication process can be avoided effectively and the membrane 3 can be formed thinly with a high yield rate. Further, a resonance frequency of the membrane 3 can be extremely raised because of the convexoconcave shape, crash/breakage by vibration can be avoided and microphonics can not be generated. Therefore, a yield rate and detection sensitivity can be enhanced simultaneously.

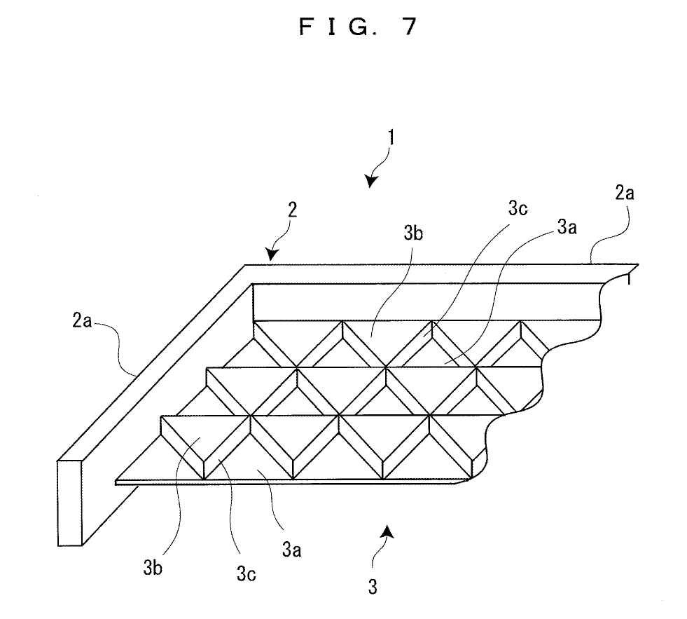

A modification of the first embodiment above will be explained with reference to FIG. 7. In the modification below, portions different from the first embodiment will be mainly explained.

The infrared ray sensor 1 according to the modification in FIG. 7 has the frame portion 2 formed in a rectangular frame shape, and the membrane 3 constructed within the frame portion 2 and formed in a convexoconcave shape. The membrane 3 in the first modification has, within the whole in-plane area of the membrane where the convexoconcave shape extends to cross obliquely, a structure in which triangular concave portions 3a and triangular convex portions 3b thereof seen horizontally are disposed in a web shape. In this case, since the peripheral walls 3c to be reinforcement ribs extend to three directions, strength of the membrane 3 can be further improved.

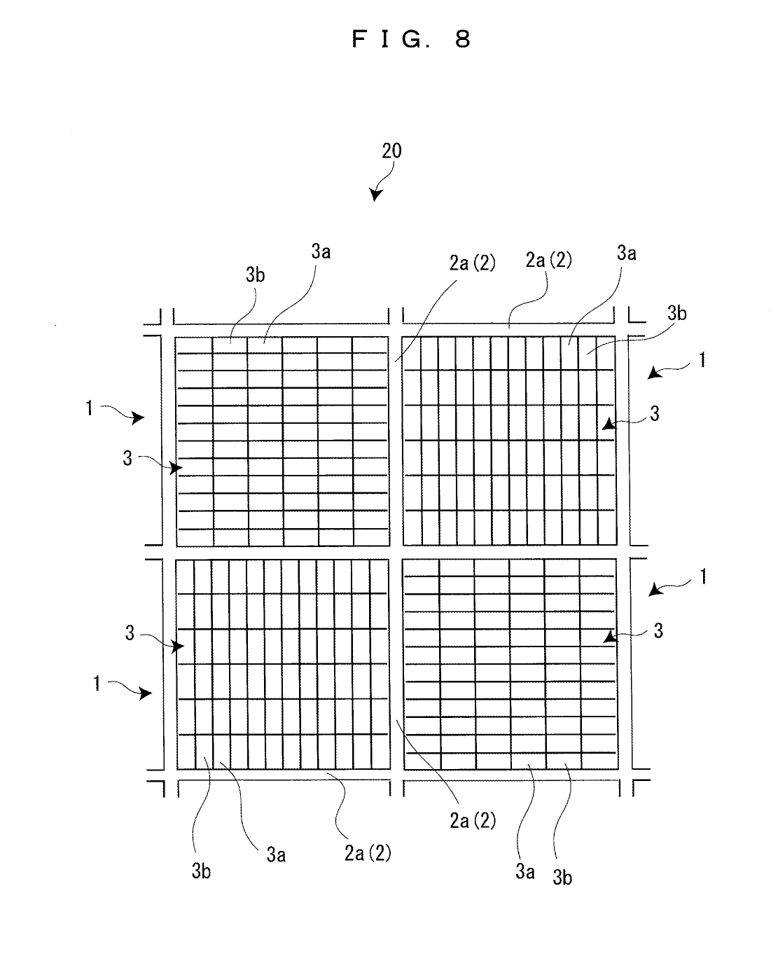

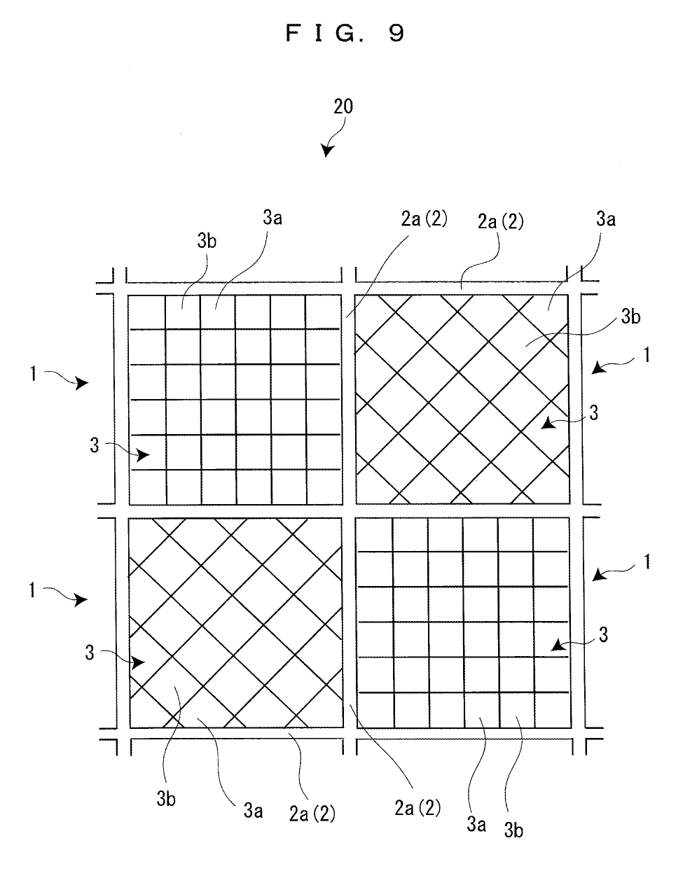

A sensor array (infrared ray detection apparatus) 20 having the infrared ray sensors 1 of the first embodiment as sensor elements will be explained with reference to FIGS. 8 and 9.

The sensor array 20 in FIG. 8 is formed by the concave portions 3a and the convex portions 3b in a rectangle seen horizontally in each infrared ray sensor 1 and is made up of a plurality of infrared ray sensors (sensor elements) 1 disposed in a planar shape without spaces therebetween. More specifically, the plurality of infrared ray sensors 1 are disposed in a state that frame portions 2 are shared in common, that is, frame pieces 2a in adjacent arbitrary two infrared ray sensors 1 are shared in common. Further, structures of convexoconcave shapes of the membranes 3 are different in the adjacent arbitrary two infrared sensors 1. In other words, the rectangular concave portions 3a and convex portions 3b in one membrane 3 are disposed, as it is called, in a horizontal direction, and the rectangular concave portions 3a and convex portions 3b are in the other membrane 3 are disposed, as it is called, in a vertical direction.

In such a sensor array 20, since the frame pieces 2a in the adjacent infrared ray sensors 1 are shared (in other words, doubled), rigidity (strength) as the whole sensor array 20 can be increased and a ratio of a total area of the membranes 3 to that of the frame portions 2 can be increased, thereby a yield ratio and detection sensitivity can be improved. Further, different resonance frequencies can be applied to the adjacent infrared ray sensors 1 and the resonance frequency can be held down for the whole sensor array 20. Therefore, it is possible to avoid crash/breakage of the sensor array 20 by vibration and the sensor array 20 suitably applied in a vehicle can be formed.

The sensor array 20 in FIG. 9 is formed in which the concave portions 3a and the convex portions 3b in each infrared ray sensor 1 are formed in a square shape seen horizontally. In this case, the plurality of infrared ray sensors 1 are also disposed in a planar surface in the state that frame portions 2 are shared in common. Further, in adjacent arbitrary two infrared ray sensors 1, one membrane 3 has a matrix structure in which the concave portions 3a and the convex portions 3b are disposed in an X axis direction and a Y axis direction, but the other membrane 3 has a matrix structure in which the concave portions 3a and the convex portions 3b are disposed to incline 45 degrees from the X axis direction and the Y axis direction. In this case, it is possible to improve a yield ratio and detection sensitivity and to avoid crash/breakage by vibration.

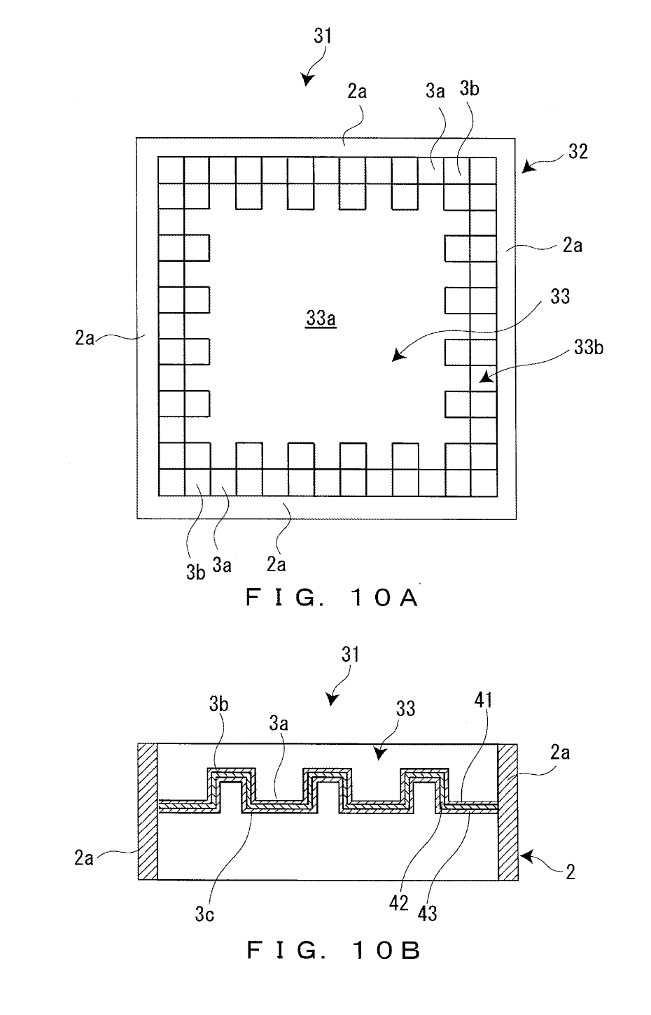

Referring to FIG. 10, a second embodiment of the invention will be explained. In the second embodiment, the invention is applied to a pressure sensor 31. The pressure sensor 31 has, as the first embodiment, a frame portion 32 formed in a rectangular frame shape, and a membrane 33 constructed within the frame portion 31 and a portion thereof is formed in a convexoconcave shape. The membrane 33 in this case is a capacitive detection type in which an upper electrode layer 41, a diaphragm 42 and a lower electrode layer 43 are laminated sequentially. The diaphragm 42 constituting a pressure reception portion is formed thinly by etching from a front side and a back side of a silicon substrate (single crystal). The membrane 33 may be an electric resistance type (piezoresistance) in which electric wirings are p-n junctions instead of the capacitive detection type.

The membrane 33 (diaphragm 42) includes a central flat portion 33a constituting a main portion of the pressure reception portion and a convexoconcave peripheral portion 33b connecting the central flat portion 33a and the frame portion 2. In this case, the peripheral portion 33b is also formed in a convexoconcave shape two-dimensionally in a planar surface and has a configuration in which the concave portions 3a and the convex portions 3b are disposed alternately. Thickness of the membrane 3 is determined based on a level of detected pressure.

In such a pressure sensor 31, as the first embodiment, since the peripheral portion 33a of the membrane 33 is formed in a convexoconcave shape, strength is integrated with the frame portion 2 and strength of the membrane 33 is improved. Therefore, it is possible to form the membrane 33 thinly with a high yield ratio. Further, it is possible to extremely raise a resonance frequency of the membrane 33 because of the convexoconcave shape, thereby crash/breakage by vibration can be avoided.

### Reference Numerals

1: infrared ray sensor
2: frame portion
3: frame piece
3: membrane
3a: concave portion
3b: convex portion
11: upper electrode layer
12: pyroelectric layer
13: lower electrode layer
20: sensor array
31: pressure sensor
32: frame portion
33: membrane
33b: peripheral portion
41: upper electrode layer
42: diaphragm
43: lower electrode layer
W: silicon substrate.

1. A sensor array comprising a plurality of sensor elements, each of which having a polygonal frame portion formed by connecting a plurality of frame pieces and a membrane that is constructed within the frame portion and has sensitivity as sensor, the plurality of sensor elements being disposed in flat shape in a state that the frame pieces in adjacent sensor elements are shared, and a peripheral portion of each membrane that is connected at least on an inner periphery of the frame portion being formed in a plurality of convexoconcave shapes.

2. (canceled)

3. The sensor array according to claim 1, wherein configurations of the plurality of convexoconcave shapes in adjacent two sensor elements are different each other.

4. The sensor array according to claim 1, wherein each convexoconcave shape extends to at least two directions and convex portions and concave portions are disposed in web form in a whole in-plane area of each membrane.

5. The sensor array according to claim 1, wherein the polygon is either one of a triangle, a quadrangle and a hexagon.

6. The sensor array according to claim 1, wherein each membrane is formed by laminating an upper electrode layer, a pyroelectric layer and a lower electrode layer.
